(19) United States
(12) Patent Application Publication
(10) Pub. No.: US 2007/0171312 A1
(43) Pub. Date: Jul. 26, 2007

(54) Frequency converter

(75) Inventor: Takahiko Kishi, Tsurumi-ku (JP)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/642,483

(22) Filed: Dec. 20, 2006

(30) Foreign Application Priority Data
Dec. 20, 2005 (JP) 366732/2005
Nov. 21, 2006 (KR) 115265/2006

(51) Int. Cl. H04N 5/455

(52) U.S. Cl. 348/726

(57) ABSTRACT

A BPF outputs a real RF signal by suppressing a band out of an RF signal frequency band in a received signal. A local oscillator outputs a complex local signal with a predetermined frequency. A half-complex mixer performs frequency conversion by multiplying the real RF signal by a real part of the local signal, performs frequency conversion by multiplying the real RF signal by an imaginary part of the local signal, and outputs a complex signal separated by the predetermined frequency from a frequency of the real RF signal. A complex-coefficient SAW filter performs a convolution integral on an impulse response generated by an even function for a real part of the complex signal, performs a convolution integral on an impulse response generated by an odd function for an imaginary part of the complex signal, and outputs a real signal by suppressing one side of a positive or negative frequency.

### PRIORITY

This application claims priority under 35 U.S.C. § 119 to applications entitled “Frequency Converter” filed in the Japan Patent Office on Dec. 20, 2005 and assigned Serial No. 2005-366732 and in the Korean Intellectual Property Office on Nov. 22, 2006 and assigned Serial No. 2006-115265, the contents of each of which are incorporated herein by reference.

### BACKGROUND OF THE INVENTION

1. Field of the Invention

The present invention relates to a frequency converter for use in a wireless transceiver.

2. Description of the Related Art

Wireless communicators function both as a receiver and a transmitter like a mobile phone. The receiver, i.e., a downconverter, receives a radio frequency (RF) signal with conversation content and data communication content and converts the received RF signal to a frequency to be input to a demodulator. Further, as a front-end scheme for selecting a target signal in the downconverter, there is a heterodyne scheme for converting an RF signal to an intermediate frequency (IF) signal without directly frequency-converting the RF signal to a baseband signal. Because this heterodyne scheme easily implements a broadband front end, the heterodyne scheme is recently attracting interest as the architecture of a front end of a software radio device. However, there are the following technical problems as well as a problem of an increase in the cost of components due to the broad band when the heterodyne scheme is applied to the broad band.

FIG. 14 illustrates a structure of a downconverter 10 serving as a frequency converter of the heterodyne scheme for down-converting an RF signal to an IF signal lower than an RF signal frequency. The downconverter of the heterodyne scheme receives the RF signal through an antenna, suppresses a band less than an RF signal frequency band saturating a front end by a first band path (or pass) filter (BPF) 1001, and outputs the RF signal frequency band. A low noise amplifier (LNA) 1002 amplifies the output signal of the BPF 1001. A second-step BPF 1003 suppresses a band out of the frequency band of a target RF signal in the amplified signal, and outputs the frequency band of the target RF signal. Then, a mixer 1004 performs conversion to a frequency of an IF signal by multiplying a signal output from the BPF 1003 by a local signal output from a local oscillator (Local) 1006. Then, a BPF 1005 outputs a frequency band of the IF signal. In wireless communication devices, the IF signal is converted to a baseband signal in a digital process. In a conventional wireless receiver, the IF signal is again frequency-converted in an analog process and is converted to the baseband signal.

On the other hand, the downconverter 10 of the heterodyne scheme down-converts bands of high and low frequency sides symmetrical to the center of the local signal of the local oscillator 106 to the same frequency band. For example, as illustrated in FIG. 15A, signals SB1 and SB2 with the center of a frequency Lo of the local signal are present in a frequency band of related positions. When the mixer 1004 performs the frequency conversion, an image frequency signal SB1-I of the signal SB1 and the signal SB2 present in the related positions are down-converted to the same frequency band. Thus, when the signal SB2 is a target signal to be output, the image frequency signal interferes with the associated target signal.

To eliminate the interference of the image frequency signal, a frequency difference between the image frequency signal SB1 and the signal SB2 serving as the RF signal before the frequency conversion increases by increasing the frequency of the IF signal as illustrated in FIG. 15B. Further, a characteristic of the BPF 1003 is set to suppress a frequency band of the image frequency signal SB1. Thus, the frequency band of the image frequency signal SB1 is suppressed. As illustrated in FIG. 15C, the effect of the image frequency signal SB1-I to the IF signal SB2 is suppressed when the mixer 1004 performs the frequency conversion.

FIG. 16 illustrates an upconverter 11 serving as a frequency converter of the heterodyne scheme for up-converting an IF signal to an RF signal greater than the frequency of the IF signal. Similar to the downconverter 10, the upconverter 11 suppresses an image frequency signal of the IF signal occurring after up-conversion. Thus, the upconverter 11 is provided with a BPF 1105 for increasing the frequency of the input IF signal and suppressing the image frequency signal of the IF signal. The image frequency signal is suppressed for the RF signal.

However, means applied to the downconverter 10 and the upconverter 11 may unnecessarily increase the frequency of the IF signal to eliminate the interference from the image frequency signal. For this reason, there is a problem in that power consumption increases in a structure after an IF stage.

There is a problem in that the image frequency signal must be able to be suppressed using a BPF of a steep characteristic or at least two BPFs since the requirements of the BPF 1003 and the BPF 1105 are strict even when the frequency of the IF signal is as low as possible. Multiple BPFs are required when an RF signal accompanied with the recent broad band has a multi-band. However, when the multiple BPFs of the steep characteristic are provided, products increases in terms of size and/or cost.

To address the above-described problems, there has been proposed the technology described in Hiroshi Tsurumi, Hiroshi Yoshida, Shoji Otaka, Hiroshi Tanimoto, Yasuo Suzuki, “Broadband and Flexible Receiver Architecture for Software Defined Radio Terminal Using Direct Conversion and Low-IF Principle”, IEICE TRANS. COMMUN., Vol. E83-B, No. 6, June 2000, pp. 1246-1253 (Tsurumi). Tsurumi proposes a downconverter 12 using a half-complex mixer (or image rejection or suppression mixer) 1203 and a polyphase filter 1204 as illustrated in FIG. 17. When an RF signal is input to the downconverter 12 as illustrated in FIG. 18A, a first BPF 1201 suppresses a signal out of a frequency band of the RF signal and an LAN 1202 amplifies the signal after suppression as illustrated in FIG. 18B. Then, the half-complex mixer 1203 performs frequency conversion while suppressing an image frequency signal SC1-I overlapping with a target signal SC2 when the amplified signal is multiplied by a complex local signal. When a frequency-converted signal is input to the polyphase filter 1204, the polyphase filter 1204 suppresses a negative frequency band as illustrated in FIG. 18D and outputs a real IF signal as illustrated in FIG. 18E. Since a BPF 1205 suppresses a frequency band out of the frequency band of the IF signal in the signal output from the polyphase filter 1204, a signal SC3 is suppressed and a signal in which the target signal SC2 overlaps with the suppressed image frequency signal SC1-I is output as illustrated in FIG. 18F.

Consequently, the image frequency signal SC1-I is suppressed in a state in which a suppression ratio of the BPF 1201 is added to a suppression ratio of the half-complex mixer 1203 and the effect of the image frequency signal to the target signal SC2 can be suppressed. The frequency of the IF signal can be limited to a low frequency without unnecessarily increasing the frequency of the IF signal only for the suppression of the image frequency signal as in the prior art. Further, a BPF such as the BPF 1003 of FIG. 14 for suppressing the band of the image frequency signal is not required.

However, the polyphase filter 1204 uses a conventional passive type filter. Since a passive polyphase filter is constructed with a RC circuit, loss is large. Since the passive polyphase filter outputs a signal without suppressing a positive frequency band, the BPF 1205 of the IF stage is mandatory to output the frequency band of the IF signal. For this reason, there is a problem in that the loss due to the polyphase filter 1204 is added to the loss due to the BPF 1205 of the IF stage when a real IF signal is output.

### SUMMARY OF THE INVENTION

Accordingly, the present invention has been designed to solve the above and other problems. Therefore, it is an object of the present invention to provide a frequency converter that can further reduce loss while limiting the frequency of an intermediate frequency (IF) signal to a low frequency in a heterodyne scheme.

In accordance with an aspect of the present invention, there is provided a frequency converter for frequency-converting a received radio frequency (RF) signal to an IF, including a real-coefficient filter for outputting a real RF signal by suppressing a band of an RF signal frequency band in a received signal; a local oscillator for outputting a complex local signal with a predetermined frequency; a complex mixer for performing frequency conversion by multiplying the real RF signal output from the real-coefficient filter by a real part of the complex local signal output from the local oscillator, performing frequency conversion by multiplying the real RF signal by an imaginary part of the complex local signal output from the local oscillator, and outputting a complex signal separated by the predetermined frequency from a frequency of the real RF signal; and a complex-coefficient transversal filter for performing a convolution integral based on an impulse response generated by an even function for a real part of the complex signal output from the complex mixer, performing a convolution integral based on an impulse response generated by an odd function for an imaginary part of the complex signal output from the complex mixer, and outputting a real signal from the complex signal by suppressing one side of a positive frequency or a negative frequency. This structure can perform frequency conversion to a low frequency while suppressing an image frequency signal in the complex mixer. When the complex signal is converted to a real signal, conversion can be performed while suppressing one side of a positive frequency or a negative frequency.

In accordance with another aspect of the present invention, there is provided a frequency converter for frequency-converting an input IF signal to an RF signal frequency, including a complex-coefficient transversal filter for performing a convolution integral based on an impulse response generated by an even function for a real signal of an input IF, performing a convolution integral based on an impulse response generated by an odd function for the real signal, and outputting a complex signal by suppressing one side of a positive frequency or a negative frequency; a local oscillator for outputting a complex local signal with a predetermined frequency; a complex mixer for performing frequency conversion by multiplying a real part of the complex signal output from the complex-coefficient transversal filter by a real part of the complex local signal output from the local oscillator, performing frequency conversion by multiplying an imaginary part of the complex signal by an imaginary part of the complex local signal output from the local oscillator, and outputting a real signal of a frequency separated by the predetermined frequency from a frequency of the input signal; and a real-coefficient filter for outputting a real RF signal by suppressing a frequency band out of an RF signal frequency band for the real signal output from the complex mixer. This structure can convert an input real signal to a complex signal while suppressing one side of a positive frequency or a negative frequency and can frequency-convert the complex signal to an RF signal frequency while suppressing an image frequency signal.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating an internal structure of a downconverter in accordance with the present invention;

FIG. 2 illustrates a frequency conversion process of the downconverter in accordance with the present invention;

FIG. 3 illustrates an impulse response of a real part of a complex-coefficient transversal filter used in the downconverter in accordance with the present invention;

FIG. 4 illustrates an impulse response of an imaginary part of the complex-coefficient transversal filter used in the downconverter in accordance with the present invention;

FIG. 5 illustrates a structure of a first complex-coefficient SAW filter used in the downconverter in accordance with the present invention;

FIG. 6 illustrates a structure of a second complex-coefficient SAW filter used in the downconverter in accordance with the present invention;

FIG. 7 is a block diagram illustrating an internal structure of an upconverter in accordance with the present invention;

FIG. 8 illustrates a structure of a first complex-coefficient SAW filter used in the upconverter in accordance with the present invention;

FIG. 9 illustrates a structure of a second complex-coefficient SAW filter used in the upconverter in accordance with the present invention;

FIG. 10 is a block diagram illustrating an internal structure of a first downconverter in accordance with the present invention;

FIG. 11 is a block diagram illustrating an internal structure of a first upconverter in accordance with the present invention;

FIG. 12 is a block diagram illustrating an internal structure of a second downconverter in accordance with the present invention;

FIG. 13 is a block diagram illustrating an internal structure of a second upconverter in accordance with the present invention;

FIG. 14 illustrates an internal structure of a downconverter in a heterodyne scheme according to the prior art;

FIG. 15 illustrates a frequency conversion process by the downconverter in the heterodyne scheme according to the prior art;

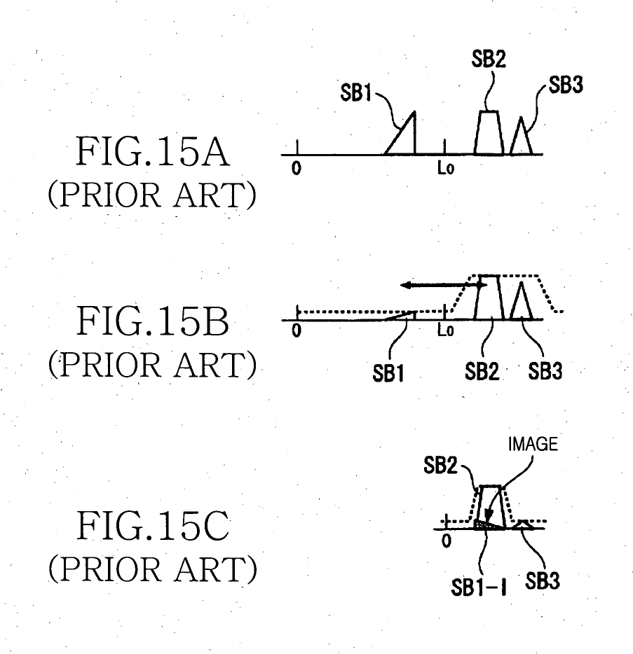

FIG. 16 illustrates an internal structure of an upconverter according to the prior art;

FIG. 17 illustrates an internal structure of a downconverter using a polyphase filter according to the prior art; and

FIG. 18 illustrates a frequency conversion process of the polyphase filter according to the prior art.

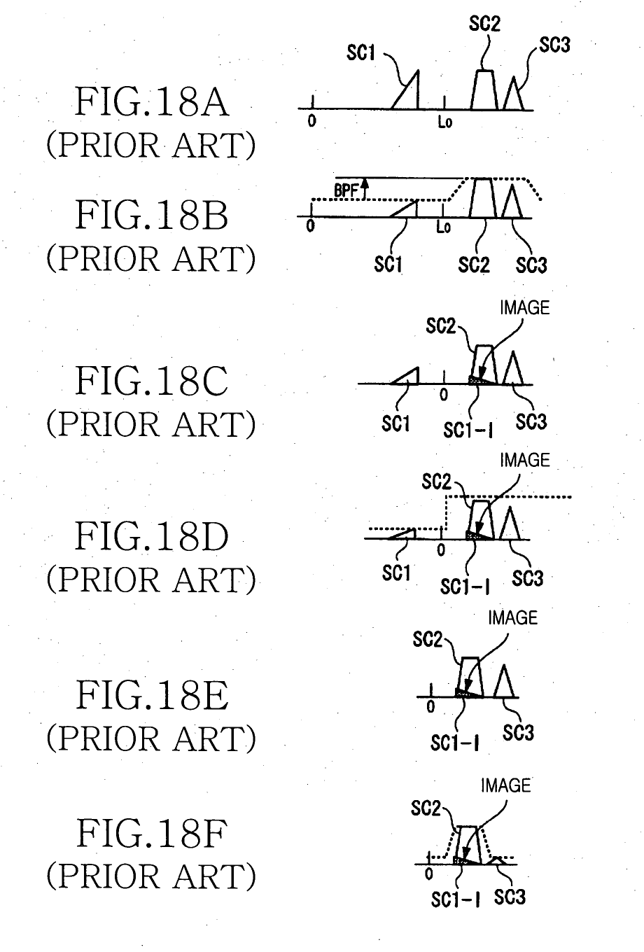

### DETAILED DESCRIPTION OF THE EXEMPLARY EMBODIMENTS

A downconverter serving as a frequency converter for frequency-converting a radio frequency (RF) signal to an intermediate frequency (IF) signal less than a frequency of the RF signal and an upconverter serving as a frequency converter for frequency-converting an IF signal to an RF signal greater than a frequency of the IF signal in accordance with the present invention will be described in detail herein below with reference to the accompanying drawings. In the following description, detailed descriptions of functions and configurations incorporated herein that are well known to those skilled in the art are omitted for clarity and conciseness.

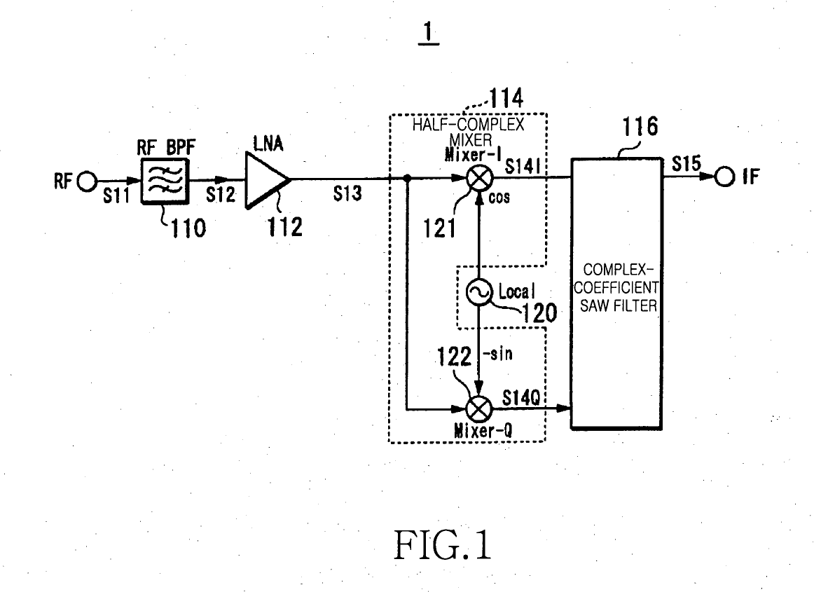

FIG. 1 is a block diagram illustrating a downconverter 1 in accordance with the present invention. The downconverter 1 is provided with a band path (or pass) filter (BPF) 110, a low noise amplifier (LNA) 112, a local oscillator 120, a half-complex mixer 114, and a complex-coefficient surface acoustic wave (SAW) filter 116. The downconverter 1 frequency-converts a received RF signal to a frequency of an IF signal, i.e., the IF signal frequency. The BPF 110 outputs a signal obtained by suppressing a band of an RF signal frequency band saturating a front end. For example, when an RF signal frequency bandwidth is set to 100 MHz, a signal of a band of 100 MHz is passed and other bands are suppressed. The LAN 112 amplifies a signal output from the BPF 110 and then outputs the amplified signal. The local oscillator (Local) 120 outputs a complex local signal constructed with a real axis local signal with a phase of cos and an imaginary local signal with a phase of −sin at a predetermined frequency. Herein, the predetermined frequency has a frequency value computed by subtracting the IF signal frequency from the RF signal frequency. The half-complex mixer 114 is connected to the local oscillator 120 and is provided with a mixer-I 121 and a mixer-Q 122 serving as multipliers. The half-complex mixer 114 outputs a complex signal of an IF frequency separated by a predetermined frequency from the frequency of the RF signal, i.e., a complex IF signal, while suppressing an image frequency signal.

In the half-complex mixer 114, the mixer-I 121 converts a real RF signal to the IF signal frequency separated by the predetermined frequency from the RF signal frequency by multiplying the real RF signal output from the LNA 112 by a real axis local signal output from the local oscillator 120, and outputs a real axis component of the complex IF signal. The mixer-Q 122 converts the real RF signal to the IF signal frequency separated by the predetermined frequency from the RF signal frequency by multiplying the real RF signal output from the LNA 112 by an imaginary axis local signal output from the local oscillator 120, and outputs an imaginary axis component of the complex IF signal.

The complex-coefficient SAW filter 116 functions as a complex-coefficient transversal filter constructed with a SAW filter. The complex-coefficient SAW filter 116 outputs a real IF signal by suppressing a negative frequency component of the complex signal output from the half-complex mixer 114 and performing a subtraction process for the complex signal after suppression.

The complex-coefficient transversal filter obtained by generalizing the filter function of the complex-coefficient SAW filter 116 and the principle of the complex-coefficient SAW filter 116 constructed with the complex-coefficient transversal filter using SAWs will be described.

The complex-coefficient transversal filter is constructed with two BPFs. One BPF performs a convolution integral with an even-symmetric impulse response for a real axis signal of an input complex signal and the other BPF performs a convolution integral with an odd-symmetric impulse response for an imaginary axis signal of the input complex signal. This structure can suppress one side of a positive frequency or a negative frequency and can obtain the filter effect of suppressing a signal out of the band of a target signal at a frequency side.

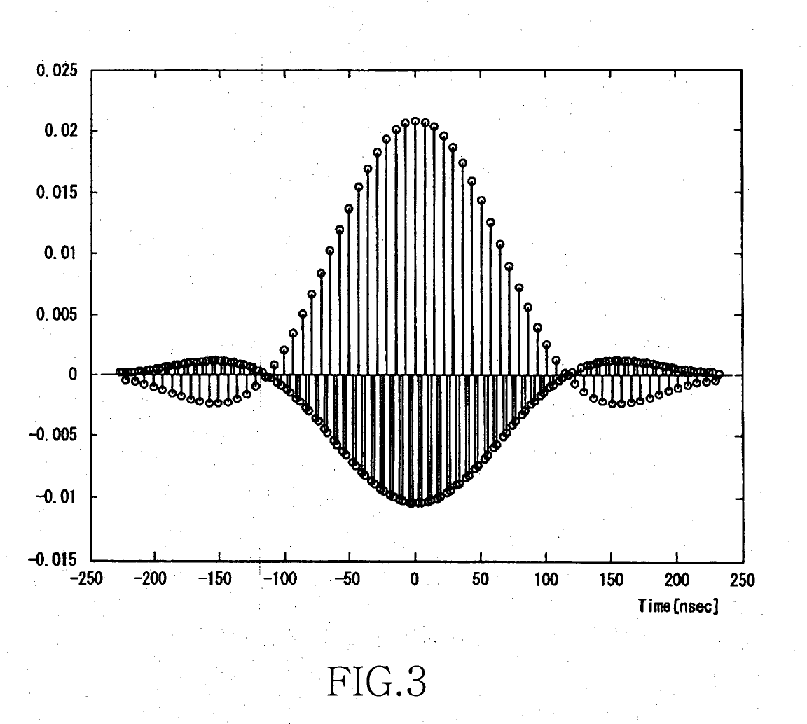

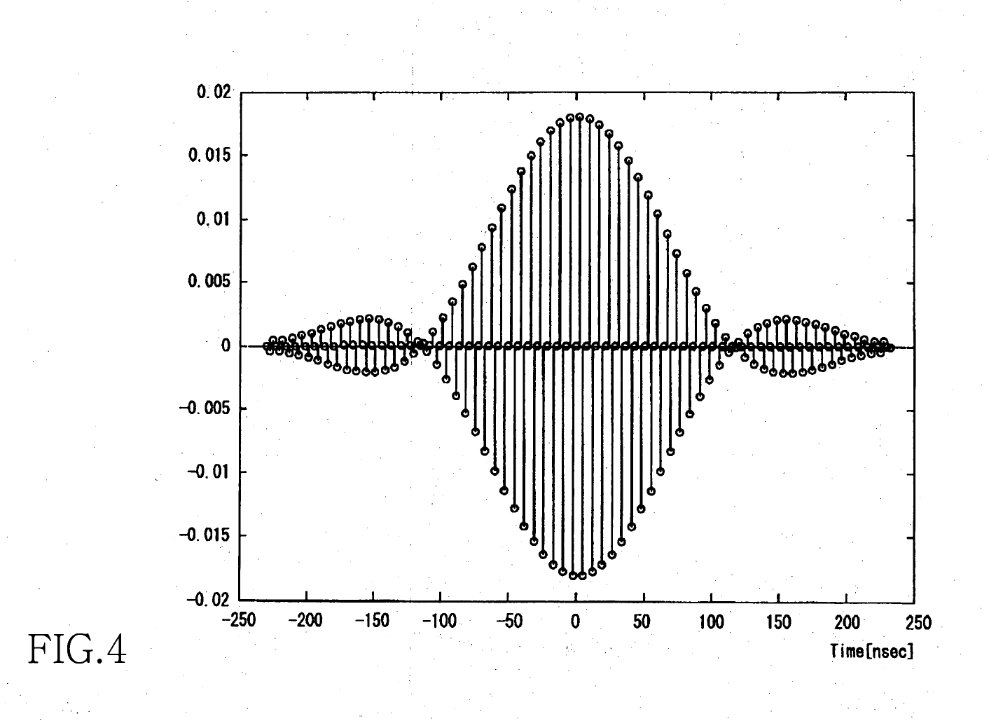

Among the impulse responses, an impulse response of a real part of the complex-coefficient transversal filter is a signal as illustrated in FIG. 3, which is even symmetric with respect to the envelope center and corresponds to the even-symmetric impulse. An impulse response of an imaginary part of the complex-coefficient transversal filter is a signal as illustrated in FIG. 4, which is odd symmetric with respect to the envelope center and corresponds to the odd-symmetric impulse. Since a phase difference between the even-symmetric impulse and the odd-symmetric impulse is 90 degrees, a signal with the phase difference of 90 degrees between the real part and the imaginary part is output when an in-phase component signal is input to the real axis signal and the imaginary axis signal.

For example, the complex-coefficient transversal filter is designed by a frequency shift method.

That is, a real-coefficient low path (or pass) filter (LPF) of a predetermined pass bandwidth Bw/2 and a stop-band attenuation amount ATT is designed and a coefficient of the real-coefficient LPF is multiplied by e^{jωt}. A filter of a center frequency ω, a pass bandwidth Bw, and a stop-band attenuation amount ATT can be obtained. In detail, the complex-coefficient transversal filter can be designed in which a center frequency ω=190 MHz, a stop-band attenuation amount ATT=35 dB, and a sampling frequency=100 MHz. Thus, the complex-coefficient transversal filter can be obtained which suppresses other frequency band signals out of a predetermined frequency band with the center of a positive frequency of 190 MHz by 35 dB.

The complex-coefficient transversal filter serving as a means for implementing the complex-coefficient transversal SAW filter 116 will be described. Conventionally, the complex-coefficient transversal filter can be implemented with a switched capacitor circuit or a charge-coupled device as well as the SAW filter. The SAW filter is suitable to implement the transversal filter of a high frequency. The basic principle of the transversal SAW filter will be described.

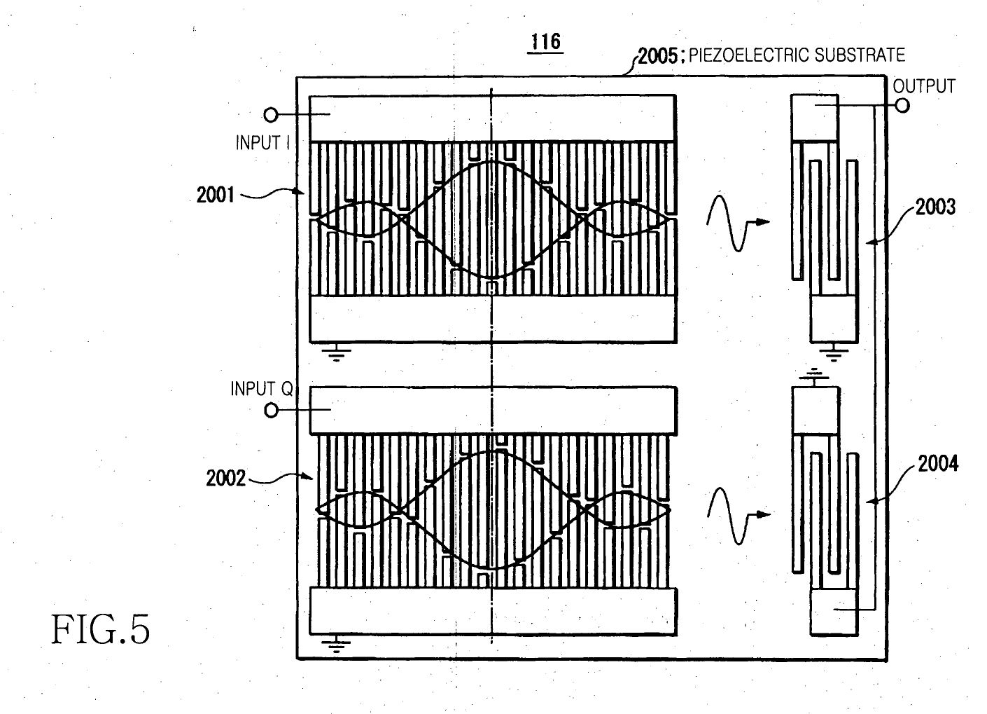

FIG. 5 illustrates a structure of the complex-coefficient SAW filter 116. The complex-coefficient SAW filter 116 is constructed with a piezoelectric substrate 2005 and comb shaped electrodes (hereinafter, referred to as Inter-Digital Transducers (IDTs)) 2001 to 2004 in which an intersection width differs according to a position on the piezoelectric substrate 2005.

Comb shaped parts are also referred to as electrode fingers.

The principle of the complex-coefficient SAW filter 116 will be described. When an impulse electric signal is applied, an impulse response of a SAW signal output as the SAW is produced on the basis of a weight function (or intersection width) Wᵢ in each electrode finger, a distance xᵢ from each electrode finger, and a phase velocity v of the SAW. A frequency transfer function H(ω) of the impulse response is expressed by Equation (1). Equation (1) represents a linear combination of the weight function Wᵢ. The basic principle of the complex-coefficient SAW filter 116 is the same as that of the complex-coefficient transversal filter.

$$H ( ω ) = {\sum }_{i = 0}^{n} {W}_{i} exp ( - \frac{j ω {x}_{i}}{v} ) \qquad ( 1 )$$

The complex-coefficient transversal filter with an associated frequency transfer function H(ω) can independently control amplitude characteristics and phase characteristics by designing Wᵢ and xᵢ. That is, the complex-coefficient transversal filter with desired characteristics can be implemented by designing Wᵢ and xᵢ of the transversal SAW filter.

To perform a weighting operation mapped to an impulse response of a real part, i.e., an even-symmetric impulse response, the IDT 2001, connected to an input terminal I for inputting a real axis component, is provided with an electrode finger such that even symmetry is formed with respect to the envelope center. To perform a weighting operation mapped to an impulse response of an imaginary part, i.e., an odd-symmetric impulse response, the IDT 2002, connected to an input terminal Q for inputting an imaginary axis component, is provided with an electrode finger such that odd symmetry is formed with respect to the envelope center.

The IDT 2003 is connected to an output terminal, and is provided on a propagation path of the IDT 2001 for performing a convolution integral of a real part. The IDT 2004 is connected to the output terminal, and is provided on a propagation path of the IDT 2002 for performing a convolution integral of an imaginary part. According to the above-described structure, SAWs excited from the IDTs 2001 and 2002 of an input side are propagated at a phase difference of 90 degrees, and are received in the IDTs 2003 and 2004 of an output side. The IDTs 2003 and 2004 are connected to each other such that phases are reverse with respect to each other. According to this structure, an imaginary component is subtracted from a real component, such that a real RF signal is output from the output terminal.

Similarly, a real RF signal can be output even when the IDTs 2001 and 2002 for which a weighting operation mapped to an impulse response is performed are connected to the output terminal and the IDTs 2003 and 2004 are connected to the input terminals.

The operation of the complex-coefficient SAW filter 116 will be described. First, when a complex RF signal is input to the input terminals, mechanical distortion is caused by piezoelectricity in the IDTs 2001 and 2002 and SAWs are excited and propagated in the left and right directions of the piezoelectric substrate 2005. The SAW signals are propagated while a convolution integral is performed on impulse responses of real and imaginary parts and the complex RF signal. The SAW signals propagated from the IDTs 2001 and 2002 are received by the IDTs 2003 and 2004 provided in propagation directions of the SAW signals, such that they are converted to electric signals. At this time, the IDT 2003 outputs a real component of the RF signal, and the IDT 2004 outputs an imaginary component of the RF signal whose polarity is inverted. The output terminal outputs a real RF signal by subtracting the imaginary component from the real component. According to this structure, the complex-coefficient SAW filter 116 can output a real IF signal while suppressing a frequency band out of the frequency band of the complex IF signal.

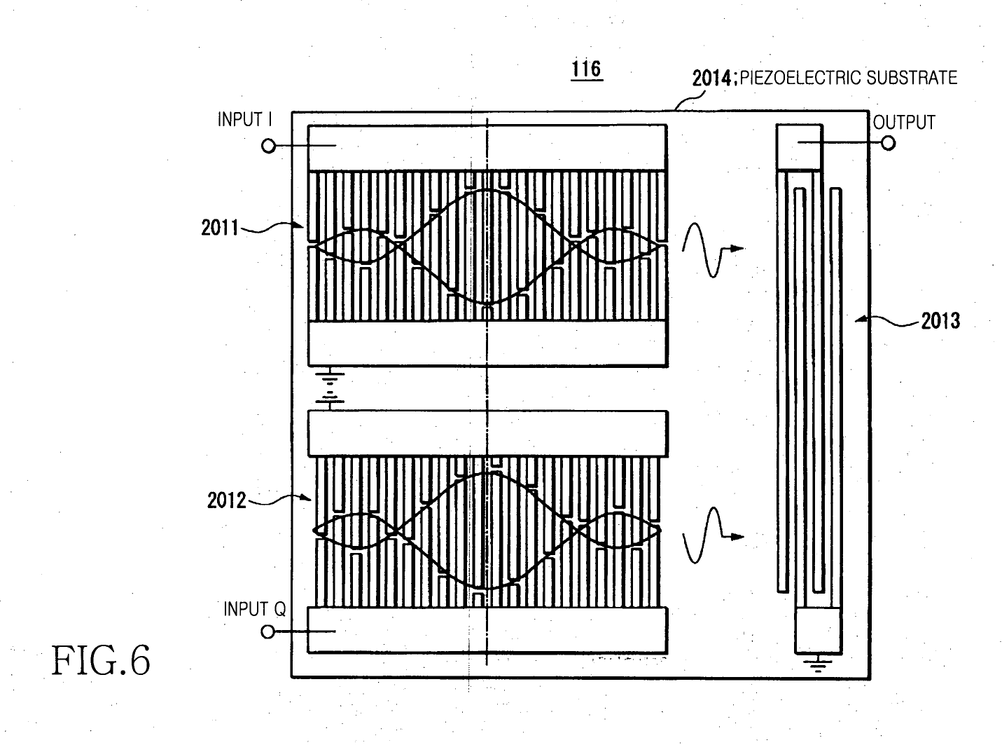

FIG. 6 illustrates another structure of the complex-coefficient SAW filter 116. The two IDTs 2003 and 2004 are provided in the output side as illustrated in FIG. 5. The complex-coefficient SAW filter 116 of FIG. 6 has a structure for receiving SAWs in one IDT 2013 connected to an output side. In this case, an IDT 2012 is provided which has an inverse of the polarity of the IDT 2002 mapped to the imaginary part of the input side of FIG. 5, such that a subtraction process can be realized. The inverse polarity is not limited to the imaginary part. The polarity of the real part may be inverted. According to this structure, one IDT can be provided in the output side.

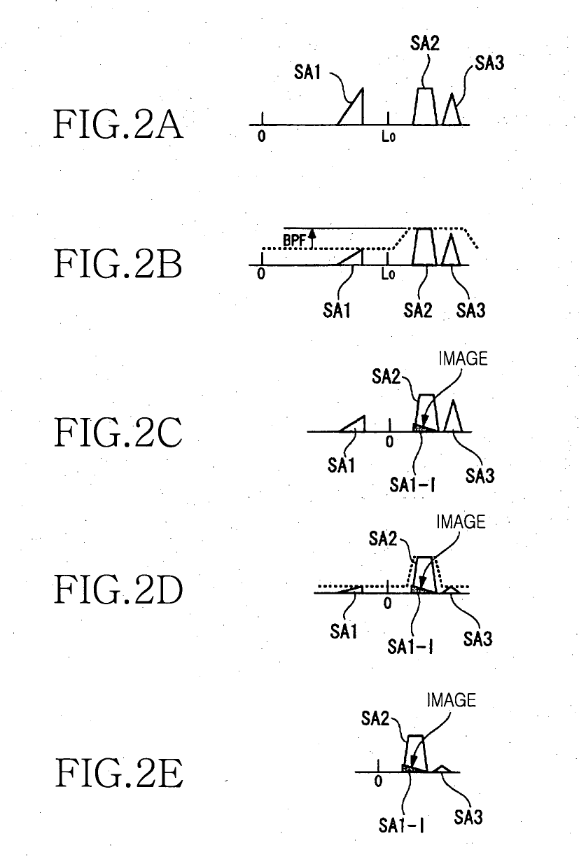

The operation of the downconverter 1 will be described with reference to FIG. 2.

A real RF signal S11 received through an antenna is input from an RF terminal. The real signal S11 includes three signals SA1, SA2, and SA3 as illustrated in FIG. 2A. A target signal to be output is the signal SA2. A signal causing an image frequency signal to the signal SA2 is the signal SA1 present in a related position with respect to the center of a predetermined frequency Lo of the local signal of the local oscillator 120. For example, when the center frequency of the signal SA2 is 800 MHz and an IF is 190 MHz, the predetermined frequency of the local signal is 610 MHz and the signal SA1 causing the image frequency signal has a frequency of 420 MHz.

When the real RF signal is input to the BPF 110, the BPF 110 outputs a signal S12 while suppressing a signal of a band out of the RF signal frequency band saturating the front end, for example, the signal SA1 of FIG. 2B.

The LAN 112 amplifies the signal S12 and a signal S13 is input to the half-complex mixer 114. The mixer-I 121 multiplies one signal branched from the signal S13 input to the half-complex mixer 114 by a real part local signal of the complex local signal with the predetermined frequency Lo output from the local oscillator 120. The mixer-Q 122 multiplies the other branched signal by an imaginary part local signal of the complex local signal with the predetermined frequency Lo output from the local oscillator 120. Thus, when the image frequency signal SA1-I related to the signal SA1 is suppressed, the half-complex mixer 114 outputs signals S14I and S14Q with a phase difference of 90 degrees from each other. A complex IF signal S14 is obtained in which a signal S14I is a real axis component and a signal S14Q is an imaginary axis component.

The complex IF signal S14 obtained through this process is shown in FIG. 2C. In FIG. 2C, the signal SA1-I is the image frequency signal mapped to the signal SA1 when the half-complex mixer 112 performs the frequency conversion. According to the above-described frequency values, the signal SA1 is at 190 MHz and the signals SA1-I and SA2 are at +190 MHz.

A strength difference between the signal SA1 and the signal SA1-I compared with the target signal SA2 is a difference due to a suppression ratio of the half-complex mixer 114 and is based on a sum of a suppression ratio of the BPF 110 and the suppression ratio of the half-complex mixer 114. For example, when the BPF 110 has the suppression ratio of about 30 dB and the half-complex mixer 114 has the suppression ratio of about 30 dB, the strength difference of the signal SA1 and the signal SA1-I is about 60 dB, such that the effect of the image frequency signal can be significantly suppressed.

If the complex-coefficient SAW filter 116 is designed at the center frequency of 190 MHz, the complex-coefficient SAW filter 116 has a filter characteristic as indicated by the dotted line of FIG. 2D. When the complex IF signal S14 is input to the complex-coefficient SAW filter 116, the signals SA2, SA1-I, and SA3 at a positive frequency undergo the convolution integral with an even-symmetric impulse response. On the other hand, the signal SA1 at a negative frequency undergoes the convolution integral with an odd-symmetric impulse response. When a subtraction process is performed for a real part signal after the convolution integral with the even-symmetric impulse response and an imaginary part signal after the convolution integral with the odd-symmetric impulse response, a real IF signal S15 is output. In detail, the signal SA2 and the suppressed image frequency SA1-I are obtained as the real IF signal S15 when the complex-coefficient SAW filter 116 suppresses a signal of a frequency band out of a target signal bandwidth with the center frequency of 190 MHz as illustrated in FIG. 2E.

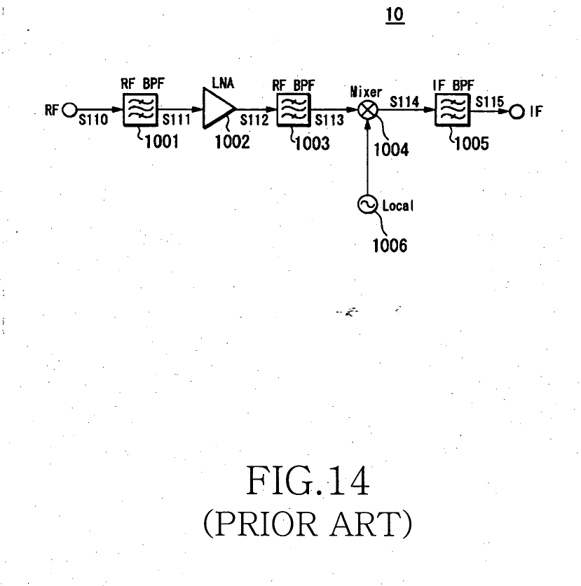

In the above-described structure, the downconverter 1 can lower the frequency of the IF signal to a low frequency without unnecessarily increasing the frequency of the IF signal only for the suppression of the image frequency signal as in the downconverter 10 of the conventional heterodyne scheme as illustrated in FIG. 14. Thus, power consumption can be reduced in a structure after an IF terminal. Since the requirement of the specification of a BPF of an input stage of an RF signal is mitigated by a suppression ratio of the half-complex mixer 114, a BPF such as the BPF 1003 of FIG. 14 requiring the steep characteristic is not required when the IF signal frequency is lowered.

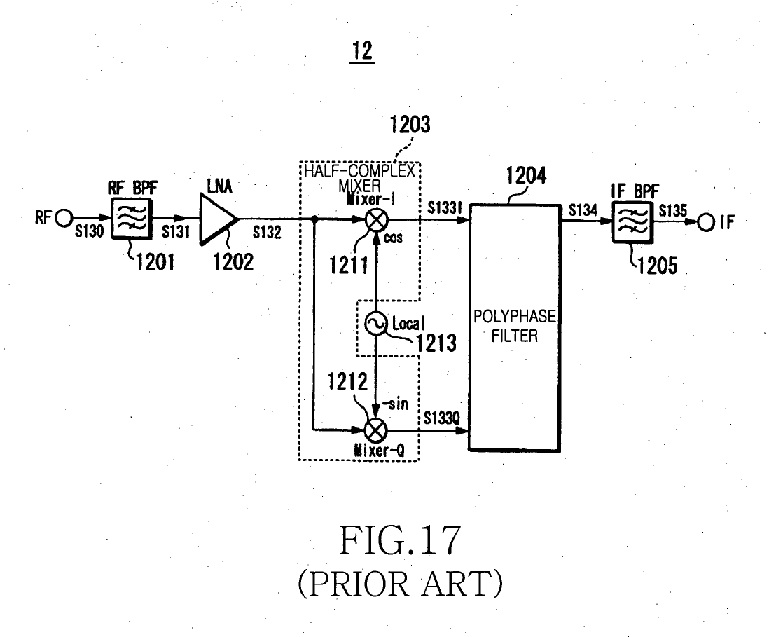

When the downconverter 1 is compared with the downconverter 12 of FIG. 17, the downconverter 12 generates a real IF signal after suppressing a negative frequency component in a polyphase filter 1204, and suppresses a frequency band out of a target signal of the associated real IF signal in a BPF 1205.

On the other hand, in the downconverter 1 of this exemplary embodiment, one complex-coefficient SAW filter 116 outputs a real IF signal from a complex IF signal while suppressing a frequency band of a target signal. Thus, the downconverter 1 of this exemplary embodiment can be miniaturized while reducing loss in the polyphase filter 1204.

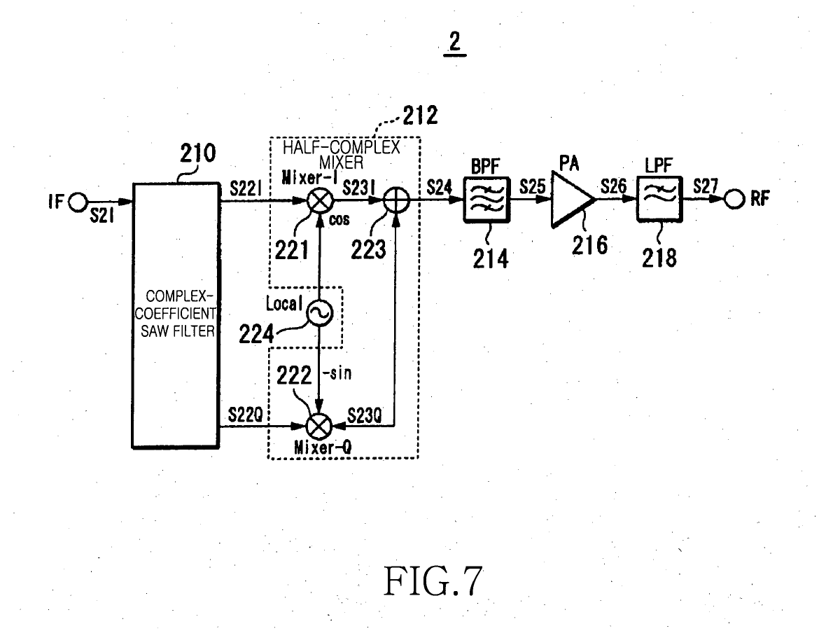

An upconverter 2 in accordance with the present invention will be described with reference to FIG. 7. The upconverter 2 is provided with a complex-coefficient SAW filter 210, a local oscillator 224, a half-complex mixer 212, a BPF 214, a power amplifier (PA) 216, and an LPF 218, and converts an IF signal to an RF signal.

In the upconverter 2, the complex-coefficient SAW filter 210 is an example of the above-described complex-coefficient transversal filter, and outputs a complex IF signal whose components have a phase difference of 90 degrees from each other while suppressing a negative frequency component of an input real IF signal. The local oscillator 240 outputs a complex local signal constructed with a real axis local signal with a phase of cos and an imaginary local signal with a phase of −sin at a predetermined frequency. Herein, the predetermined frequency has a frequency value computed by subtracting the IF signal frequency from the RF signal frequency. The half-complex mixer 212 is connected to the local oscillator 224 and is provided with a mixer-I 221 and a mixer-Q 222 serving as multipliers and an adder 223. The half-complex mixer 212 multiplies the complex signal output from the complex-coefficient SAW filter 210 by the complex local signal, and performs frequency conversion to a real RF signal while suppressing an image frequency signal.

The mixer-I 221 performs the frequency conversion to the RF signal frequency separated by the predetermined frequency from the IF signal frequency by multiplying a real axis signal of the input complex signal by the real axis local signal output from the local oscillator 224. The mixer-Q 222 performs the frequency conversion to the RF signal frequency separated by the predetermined frequency from the IF signal frequency by multiplying an imaginary axis signal of the input complex signal by the imaginary axis local signal output from the local oscillator 224. The adder 223 outputs a real RF signal by adding a signal output from the mixer-I 221 to a signal output from the mixer-Q 222. The BPF 214 suppresses a band out of the RF signal frequency band. The PA 216 amplifies a real RF signal output from the BPF 214. The LPF 218 suppresses a frequency component of the real RF signal.

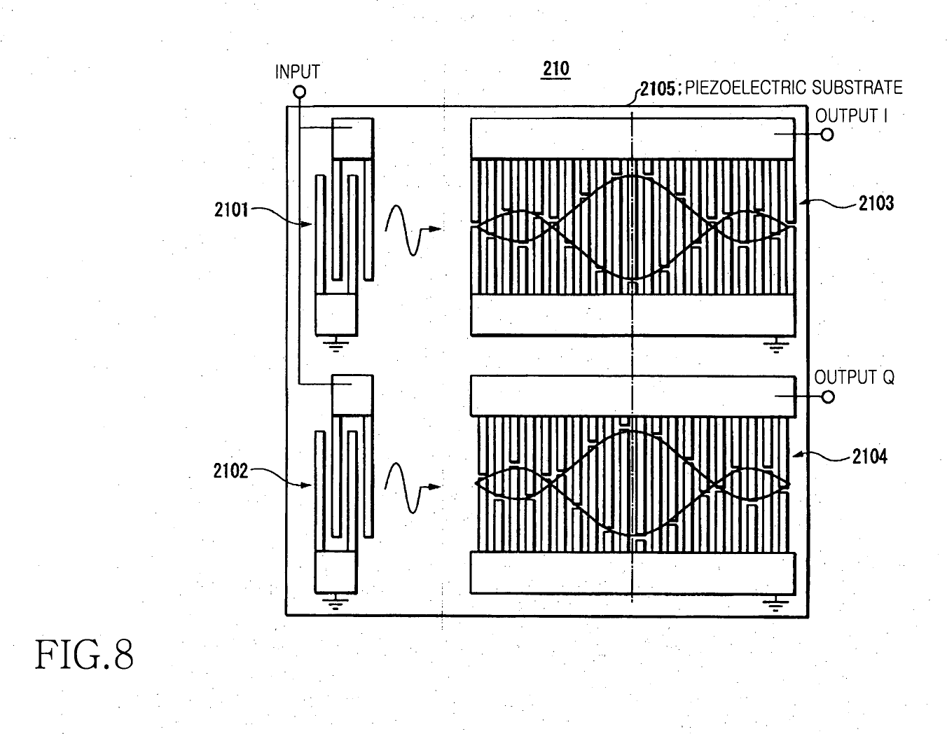

The complex-coefficient SAW filter 210 can have a structure as illustrated in FIG. 8. The complex-coefficient SAW filter 210 of FIG. 8 is constructed with a piezoelectric substrate 2105 and comb shaped electrodes 2101 to 2104 in which an intersection width differs according to a position on the piezoelectric substrate 2105. The IDTs 2101 and 2102 are connected to an input terminal. When an impulse electric signal is applied, mechanical distortion is caused by piezoelectricity and SAWs are excited and propagated in the left and right directions of the piezoelectric substrate 2105. The IDT 2103 is connected to an output terminal I for outputting a real axis component and is provided in a position capable of receiving the SAW from the IDT 2101. The IDT 2104 is connected to an output terminal Q for outputting an imaginary axis component and is provided in a position capable of receiving the SAW from the IDT 2102. To perform a weighting operation mapped to an impulse response of a real part, i.e., an even-symmetric impulse response, the IDT 2103, connected to the output terminal I for outputting the real axis component, is provided with an electrode finger such that even symmetry is formed with respect to the envelope center. To perform a weighting operation mapped to an impulse response of an imaginary part, i.e., an odd-symmetric impulse response, the IDT 2104, connected to the output terminal Q for outputting an imaginary axis component, is provided with an electrode finger such that odd symmetry is formed with respect to the envelope center. This structure can convert a real IF signal to a complex IF signal with a phase difference of 90 degrees between the real part and the imaginary part while suppressing a negative frequency signal.

The operation of the complex-coefficient SAW filter 210 will be described. First, when a real IF signal is input to the input terminal, SAWs are excited and propagated from the IDTs 2101 and 2102. The SAWs propagated from the IDTs 2101 and 2102 are received by the IDTs 2103 and 2104 provided in propagation directions of the SAWs. A convolution integral is performed on the basis of impulse responses mapped to the SAWs, such that they are converted to electric signals. At this time, the IDT 2103 outputs a real part component of the complex IF signal through the output terminal I, and the IDT 2104 outputs an imaginary part component of the complex IF signal through the output terminal Q. According to this structure, a convolution integral is performed for the even and odd-symmetric impulse responses and the real IF signal, such that the complex IF signal whose components have a phase difference of 90 degrees from each other can be output while a negative frequency band of the real IF signal is suppressed.

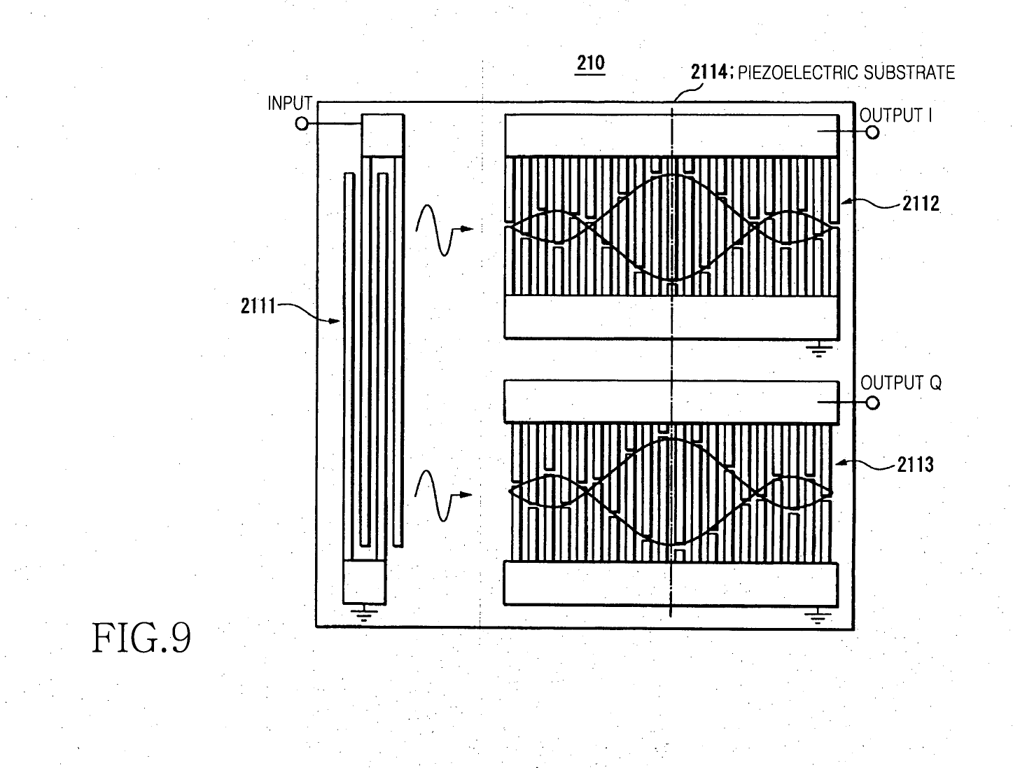

Further, the complex-coefficient SAW filter 210 can be implemented with the structure of FIG. 9. The structure of FIG. 8 is provided with the two IDTs 2101 and 2102 in the input terminal side, whereas the structure of FIG. 9 is provided with an IDT 1211 of an input side placed across propagation paths of IDTs 2112 and 2113 connected to output terminals. In this structure, one IDT can be provided in the input terminal side.

The operation of the upconverter 2 will be described with reference to FIG. 7.

First, a real IF signal S21 is input from an IF terminal to the complex-coefficient SAW filter 210.

If the complex-coefficient SAW filter 210 is designed at the center frequency of 190 MHz, the complex-coefficient SAW filter 210 outputs signals S221 and S22Q with a phase difference of 90 degrees from each other while suppressing a band out of a frequency band with the center frequency of 190 MHz in the real IF signal. The signal S22I is a real axis component of the complex IF signal and the signal S22Q is an imaginary axis component of the complex IF signal.

In the half-complex mixer 212, the mixer-I 221 multiplies the signal S22I corresponding to the real axis component of the complex IF signal output from the complex-coefficient SAW filter 210 by the real part local signal of the complex local signal with the predetermined frequency output from the local oscillator 224. The mixer-Q 222 multiplies the signal S22Q corresponding to the imaginary axis component of the complex IF signal output from the complex-coefficient SAW filter 210 by the imaginary part local signal of the complex local signal with the predetermined frequency output from the local oscillator 224. Thus, while the image frequency signal occurring in the RF signal frequency band is suppressed by frequency conversion, the mixer-I 221 and the mixer-Q 222 output a signal S23I and a signal S23Q, respectively. The adder 223 adds the signal S23I to the signal S23Q and then outputs a real RF signal S24.

The BPF 214 outputs a real RF signal S25 by suppressing a band out of the RF signal frequency band in the input RF signal. The PA 216 amplifies the real RF signal S25. The LPF 218 rejects a high frequency component from the real RF signal S25 and then an antenna transmits a signal from an RF terminal.

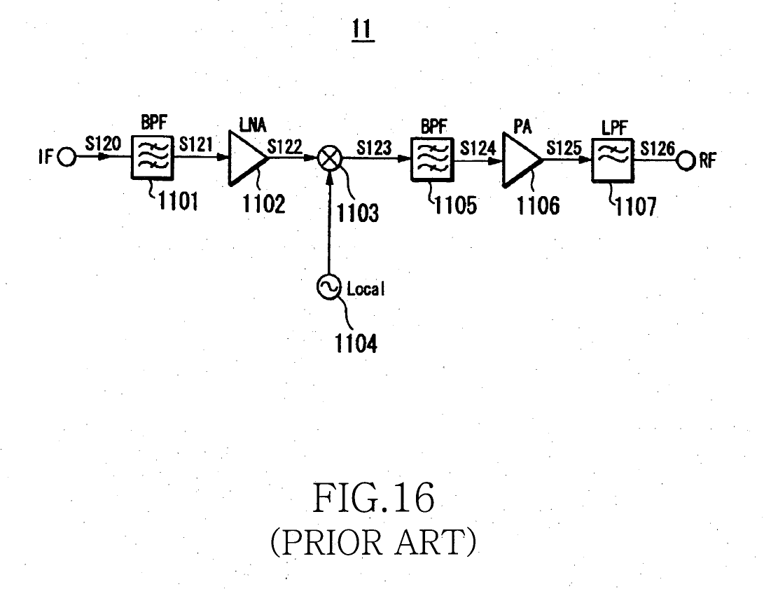

In the above-described structure, the upconverter 2 can lower the frequency of the input IF signal to a low frequency without unnecessarily increasing the frequency of the input IF signal only for the suppression of the image frequency signal as in the upconverter 11 of the heterodyne scheme as illustrated in FIG. 16. Thus, power consumption can be reduced in a structure of an IF stage. Since the requirement of the specification of a BPF of an output stage of an RF signal is mitigated by a suppression ratio of the half-complex mixer 212, a BPF such as the BPF 1105 of FIG. 16 requiring the steep characteristic is not required when the IF signal frequency is lowered.

When the upconverter 2 is compared with the upconverter mapped to the downconverter 12 of FIG. 17, the upconverter 2 of this exemplary embodiment suppresses a frequency band out of a target signal from a real IF signal in the complex-coefficient SAW filter 210, whereas the upconverter mapped to the downconverter 12 requires a BPF for suppressing a frequency band out of an IF signal frequency band before an input to a polyphase filter. Thus, the upconverter 2 of this exemplary embodiment can be miniaturized while reducing loss in the polyphase filter.

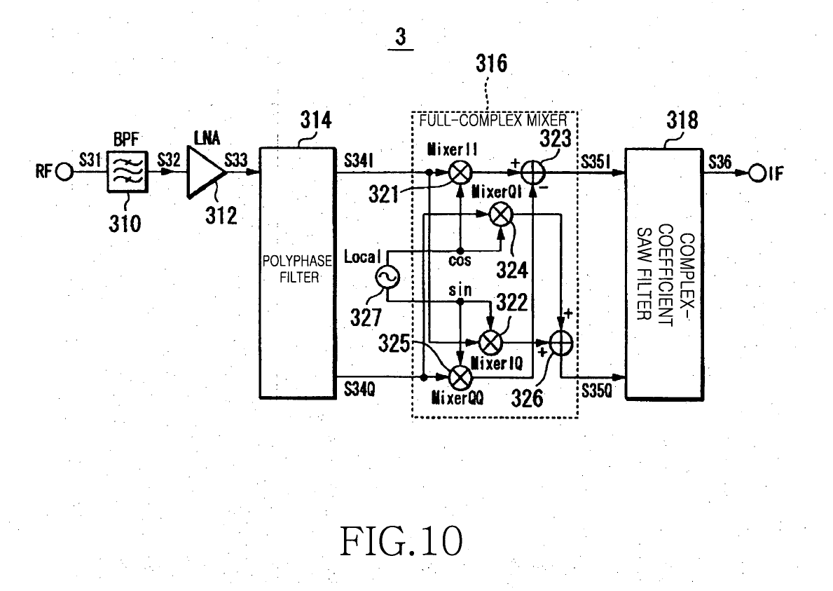

A downconverter 3, an upconverter 4, a downconverter 5, and an upconverter 6 in accordance with other embodiments of the present invention will be described with reference to FIGS. 10, 11, 12, and 13.

The downconverter 3 of FIG. 10 is provided with a BPF 310, an LNA 312, a polyphase filter 314, a local oscillator 327, a full-complex mixer 316, and a complex-coefficient SAW filter 318. The BPF 310 corresponds to the BPF 110 of FIG. 1 and the LNA 312 corresponds to the LNA 112 of FIG. 1. The polyphase filter 314 outputs a complex RF signal by suppressing a negative frequency of an input real RF signal. The local oscillator 327 outputs a complex local signal constructed with a real axis local signal with a phase of cos and an imaginary local signal with a phase of sin at a predetermined frequency. Herein, the predetermined frequency has a frequency value computed by subtracting the IF signal frequency from the RF signal frequency.

The full-complex mixer 316 is connected to the local oscillator 327 and is provided with a mixer-II 321, a mixer-IQ 322, a mixer-QI 324, a mixer-QQ 325, a subtractor 323, and an adder 326. An example is described in FIG. 3.28 and FIG. 3.31 of CMOS WIRELESS TRANSCEIVER DESIGN, Jan Crols, Michiel Steyaert, Kluwer, International Series in Engineering and Computer Science, 1997 (Crols). In the full-complex mixer 316, the real axis local signal of the complex local signal output from the local oscillator 327 is input to the mixer-II 321 and the mixer-QI 324 and the imaginary axis local signal of the complex local signal output from the local oscillator 327 is input to the mixer-IQ 322 and the mixer-QQ 325.

The mixer-II 321 multiplies a signal S34I of a real axis component of the complex RF signal output from the polyphase filter 314 by the real axis local signal of the complex local signal. The mixer-IQ 322 performs multiplication by the imaginary axis local signal of the complex local signal. Thus, an image frequency signal is suppressed and frequency conversion to an IF signal frequency is performed.

The mixer-QQ 325 multiplies a signal S34Q of an imaginary axis component of the complex RF signal output from the polyphase filter 314 by the imaginary axis local signal of the complex local signal. The mixer-QI 324 performs multiplication by the real axis local signal of the complex local signal. Thus, an image frequency signal is suppressed and frequency conversion to an IF signal frequency is performed. The subtractor 323 subtracts an output signal of the mixer-QQ 325 from an output signal of the mixer-II 321 and outputs a signal S35I corresponding to the real axis component of the complex IF signal. The adder 326 adds an output signal of the mixer-QI 324 to an output signal of the mixer-IQ 322, and then outputs a signal S35Q corresponding to an imaginary axis component of the complex IF signal.

The full-complex mixer 316 multiplies both the real and imaginary axis components of the complex RF signal to be frequency-converted by the real and imaginary axis components of the complex local signal, thereby suppressing the image frequency signal occurring in the frequency conversion at a high suppression ratio.

The complex-coefficient SAW filter 318 uses the SAW filter with the structure of FIG. 2 or 3. The signal S35I corresponding to the real axis component of the complex IF signal output from the full-complex mixer 316 undergoes a convolution integral with an even-symmetric impulse response. On the other hand, the signal S35Q corresponding to the imaginary axis component of the complex IF signal undergoes a convolution integral with an odd-symmetric impulse response. Further, a subtraction process is performed for a real part signal after the convolution integral with the even-symmetric impulse response and an imaginary part signal after the convolution integral with the odd-symmetric impulse response and then a real IF signal S36 is output.

According to the above-described structure, the downconverter 3 is provided with the polyphase filter 314, and can generate the complex RF signal by suppressing a negative frequency component. Thus, the downconverter 3 can suppress the image frequency signal at a suppression ratio in which a suppression ratio of the full-complex mixer 316 is added to a suppression ratio of the polyphase filter 314. Since the downconverter 3 uses the full-complex mixer 316, the downconverter 3 can obtain a higher suppression ratio than the downconverter 1 using the half-complex mixer 114. Since a high suppression ratio can be obtained by the full-complex mixer 316, the degradation of an image suppression ratio due to the variation of a transistor can be allowed. For this reason, a size of the transistor of the full-complex mixer 316 can be small. The full-complex mixer has a larger number of transistors than the half-complex mixer but the overall power consumption can be reduced due to the reduction of power consumption of an individual transistor. Simultaneously, the degradation of transition frequency, fT, of the transistor can be prevented.

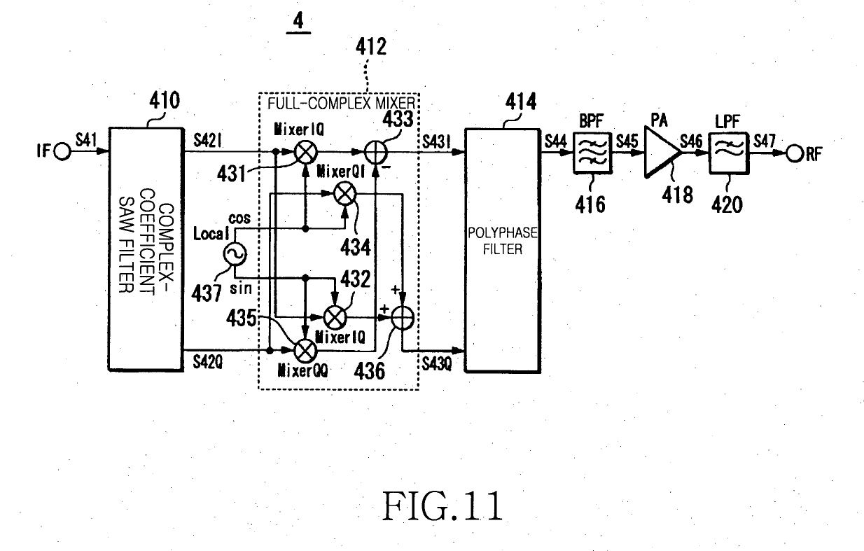

FIG. 11 illustrates a structure of the upconverter 4 mapped to the structure of the downconverter 3 of FIG. 10. The upconverter 4 is provided with a complex-coefficient SAW filter 410, a full-complex mixer 412, a polyphase filter 414, a BPF 416, a PA 418, and an LPF 420. The BPF 416 corresponds to the BPF 214 of FIG. 7, the PA 418 corresponds to the PA 216 of FIG. 7, and the LPF 420 corresponds to the LPF 218 of FIG. 7. The complex-coefficient SAW filter 410 uses the SAW filter with the structure of FIG. 8 or 9.

In the upconverter 4, the complex-coefficient SAW filter 410 first generates and outputs a complex IF signal with a phase difference of 90 degrees between real and imaginary parts while suppressing a negative frequency component of an input real IF signal. The full-complex mixer 412 performs frequency conversion to an RF signal frequency by multiplying a complex local signal of a predetermined frequency output from the local oscillator 437 by all combinations of real and imaginary axis components of the input complex IF signal. The polyphase filter 414 converts a complex RF signal output from the full-complex mixer 412 to a real RF signal by suppressing a negative frequency component. Then, the BPF 416 suppresses a band out of an RF signal frequency band in the input real RF signal. The PA 418 amplifies the real RF signal after suppression. Then, the LPF 420 rejects a harmonic frequency component and an antenna transmits a signal from an RF terminal.

According to the above-described structure, the upconverter 4 using the full-complex mixer 412 can obtain a higher suppression ratio than the upconverter 2 using the half-complex mixer 212.

Further, the upconverter 4 is provided with the polyphase filter 414, and can generate the real RF signal by suppressing a negative frequency component. Thus, the upconverter 4 can suppress the image frequency signal at a suppression ratio in which a suppression ratio of the full-complex mixer 412 is added to a suppression ratio of the polyphase filter 414. Because a high suppression ratio can be obtained by the full-complex mixer 412, the degradation of an image suppression ratio due to the variation of a transistor can be allowed. For this reason, a size of the transistor of the full-complex mixer 412 can be small. The full-complex mixer has a larger number of transistors than the half-complex mixer but the overall power consumption can be reduced due to the reduction of power consumption of an individual transistor. Simultaneously, the degradation of transition frequency, fT, of the transistor can be prevented.

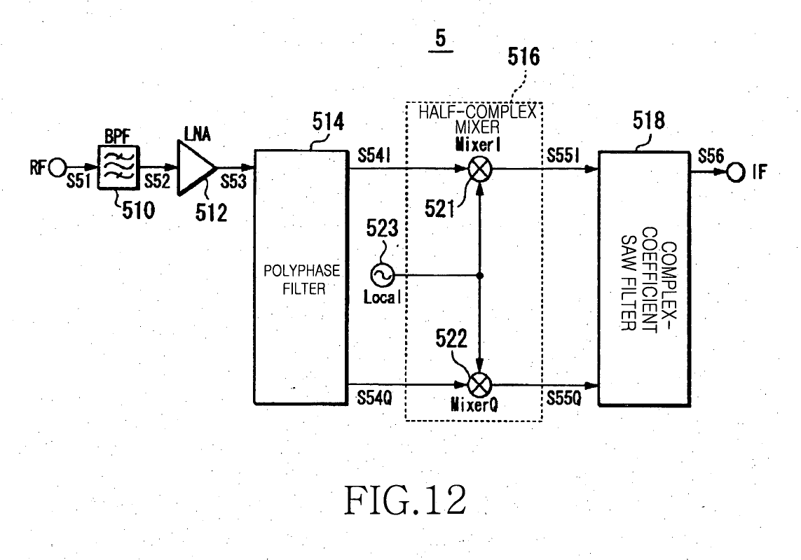

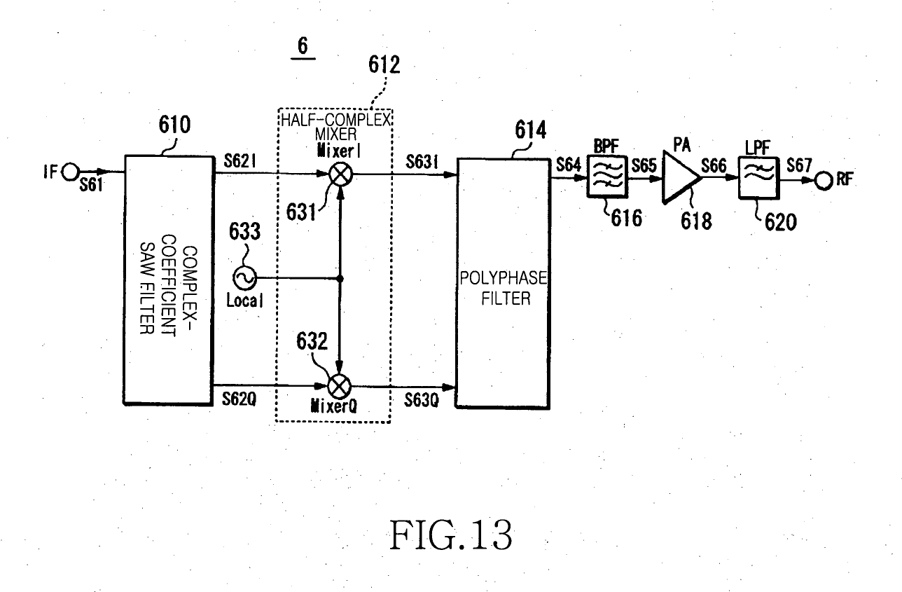

The downconverter 5 and the upconverter 6 will be described with reference to FIGS. 12 and 13.

The downconverter 5 of FIG. 12 is provided with a BPF 510, an LNA 512, a polyphase filter 514, a local oscillator 523, a half-complex mixer 516, and a complex-coefficient SAW filter 518. The BPF 510 corresponds to the BPF 110 of FIG. 1 and the LNA 512 corresponds to the LNA 112 of FIG. 1. The polyphase filter 514 outputs a complex RF signal by suppressing a negative frequency of an input real RF signal. The local oscillator 523 inputs a real local signal with a predetermined frequency. Herein, the predetermined frequency has a frequency value computed by subtracting the IF signal frequency from the RF signal frequency. The half-complex mixer 516 is connected to the local oscillator 523 and is provided with a mixer-I 521 and a mixer-Q 522. The half-complex mixer 516 frequency-converts the input complex RF signal to a complex IF signal while suppressing an image frequency signal.

In the half-complex mixer 516, the mixer-I 521 outputs a signal S55I converted to an IF signal frequency separated by a predetermined frequency from an RF signal frequency by multiplying a signal S54I corresponding to a real axis component of the complex RF signal output from the polyphase filter 514 by the real local signal output from the local oscillator 523. The mixer-Q 522 outputs a signal S55Q converted to the IF signal frequency separated by the predetermined frequency from the RF signal frequency by multiplying a signal S54Q corresponding to an imaginary axis component of the complex RF signal output from the polyphase filter 514 by the real local signal output from the local oscillator 523.

The complex-coefficient SAW filter 518 uses the SAW filter with the structure of FIG. 2 or 3. A signal S55I corresponding to the real axis component of the complex IF signal output from the full-complex mixer 516 undergoes a convolution integral with an even-symmetric impulse response. On the other hand, a signal S55Q corresponding to the imaginary axis component of the complex IF signal undergoes a convolution integral with an odd-symmetric impulse response. Further, a subtraction process is performed for a real part signal after the convolution integral with the even-symmetric impulse response and an imaginary part signal after the convolution integral with the odd-symmetric impulse response and then a real IF signal S56 is output.

According to the above-described structure, the downconverter 5 is provided with the polyphase filter 514 in an RF signal stage, and can generate the complex RF signal by suppressing a negative frequency component. Thus, the downconverter 5 can suppress the image frequency signal at a suppression ratio in which a suppression ratio of the full-complex mixer 516 is added to a suppression ratio of the polyphase filter 514. Since a local signal input to the half-complex mixer 516 is a real local signal, the power consumption of the downconverter 5 can be reduced to half of that of the downconverter 1 using the complex local signal. Using the real local signal, the downconverter 5 can obtain a sufficient suppression ratio at which an image frequency signal is suppressed by suppressing variation due to a manufacturing error of a mixer or filter without considering the imbalance between a real number and an imaginary number.

FIG. 13 illustrates a structure of the upconverter 6 mapped to the structure of the downconverter 5 of FIG. 12. The upconverter 6 is provided with a complex-coefficient SAW filter 610, a half-complex mixer 612, a polyphase filter 614, a BPF 616, a PA 618, and an LPF 620. The BPF 616 corresponds to the BPF 214 of FIG. 7, the PA 618 corresponds to the PA 216 of FIG. 7, and the LPF 620 corresponds to the LPF 218 of FIG. 7. The complex-coefficient SAW filter 610 uses the SAW filter with the structure of FIG. 8 or 9.

In the upconverter 6, the complex-coefficient SAW filter 610 first generates and outputs a complex IF signal with a phase difference of 90 degrees between real and imaginary parts while suppressing a negative frequency component of an input real IF signal. The half-complex mixer 612 multiplies signals corresponding to real and imaginary axis components of an input IF signal by a real local signal with a predetermined frequency output from a local oscillator 633, and then outputs a complex RF signal by performing frequency conversion to an RF signal frequency. The polyphase filter 614 converts the complex RF signal output from the half-complex mixer 612 to a real RF signal by suppressing a negative frequency component. Then, the BPF 616 suppresses a band out of an RF signal frequency band in the input real RF signal. The PA 618 amplifies the real RF signal after suppression. Then, the LPF 420 rejects a harmonic frequency component from the real RF signal and an antenna transmits a signal from an RF terminal.

According to the above-described structure, the upconverter 6 is provided with the polyphase filter 614 in an RF signal stage, and can generate the real RF signal by suppressing a negative frequency component. Thus, the upconverter 6 can suppress the image frequency signal at a suppression ratio in which a suppression ratio of the half-complex mixer 612 is added to a suppression ratio of the polyphase filter 614. Since a local signal input to the half-complex mixer 612 is a real local signal, the power consumption of the upconverter 6 can be reduced to half of that of the upconverter 2 using the complex local signal. Using the real local signal, the upconverter 6 can obtain a sufficient suppression ratio at which an image frequency signal is suppressed by suppressing variation due to a manufacturing error of a mixer or filter without considering the imbalance between a real number and an imaginary number.

If flat group delay characteristics are required for the complex-coefficient transversal filter, an impulse response used for the complex-coefficient transversal filter must be exactly an even or odd symmetric impulse response. However, because symmetry may be slightly lost when the impulse response is generated based on an even or odd function, an almost even or odd-symmetric impulse response is also possible if flat group delay characteristics are not precisely required.

Alternatively, the complex-coefficient transversal filter and the complex-coefficient SAW filter of its exemplary embodiment may suppress a positive frequency on the basis of the above-described design and may suppress a band out of a frequency band of a target signal of a negative frequency.

Alternatively, the polyphase filter may be constructed to suppress the positive frequency rather than the negative frequency.

In accordance with the present invention, a frequency converter includes a real-coefficient filter for outputting a real RF signal by suppressing a band out of an RF signal frequency band in a received signal, a local oscillator for outputting a complex local signal with a predetermined frequency, a complex mixer for performing frequency conversion by multiplying the real RF signal output from the real-coefficient filter by a real part of the complex local signal output from the local oscillator, performing frequency conversion by multiplying the real RF signal by an imaginary part of the complex local signal output from the local oscillator, and outputting a complex signal of a frequency separated by the predetermined frequency from a frequency of the real RF signal, and a complex-coefficient transversal filter for performing a convolution integral based on an impulse response generated by an even function for a real part of the complex signal output from the complex mixer, performing a convolution integral based on an impulse response generated by an odd function for an imaginary part of the complex signal output from the complex mixer, and outputting a real signal from the complex signal by suppressing one side of a positive frequency or a negative frequency. Thus, the frequency converter of a heterodyne scheme can lower an IF signal frequency to a low frequency, and can reduce power consumption in a structure after an IF stage. When the frequency converter of the present invention is compared with that of the downconverter using the conventional polyphase filter, the frequency converter of the present invention can reduce loss due to the polyphase filter.

In the frequency converter of the present invention, the complex-coefficient transversal filter is constructed with a SAW filter. Since the SAW filter is a passive filter, power is not consumed. The SAW filter can suppress one side of a positive frequency or a negative frequency and can obtain the filter effect of suppressing a signal out of the band of a target signal at a frequency side.

In accordance with the present invention, the frequency converter is provided with a polyphase filter connected to the real-coefficient filter and the complex mixer. The polyphase filter generates and outputs a complex RF signal by suppressing one side of a positive frequency or a negative frequency from the real RF signal output from the real-coefficient filter. The complex mixer performs frequency conversion by multiplying a real part of the complex RF signal output from the polyphase filter by the real part of the complex local signal output from the local oscillator, performs frequency conversion by multiplying an imaginary part of the complex RF signal output from the polyphase filter by the imaginary part of the complex local signal output from the local oscillator, and outputs a complex signal of a frequency separated by the predetermined frequency from a frequency of the complex RF signal. Since the polyphase filter can generate the complex RF signal by suppressing a positive or negative frequency component, an image frequency signal can be suppressed at a suppression ratio in which a suppression ratio of the complex mixer is added to a suppression ratio of the polyphase filter.

In the frequency converter of the present invention, the local oscillator outputs a real local signal with a predetermined frequency, and the complex mixer performs frequency conversion by multiplying the real part of the complex RF signal output from the polyphase filter by the real local signal output from the local oscillator, performs frequency conversion by multiplying the imaginary part of the complex RF signal output from the polyphase filter by the real local signal output from the local oscillator, and outputs a complex signal of a frequency separated by the predetermined frequency from a frequency of the complex RF signal. Since a local signal input to the complex mixer is a real local signal, the power consumption of the frequency converter can be reduced to half of that of the frequency converter using the complex local signal. Using the real local signal, the frequency converter can obtain a sufficient suppression ratio at which an image frequency signal is suppressed by suppressing variation due to a manufacturing error of a mixer or filter without considering the imbalance between a real number and an imaginary number.

In accordance with the present invention, a frequency converter includes a complex-coefficient transversal filter for performing a convolution integral based on an impulse response generated by an even function for a real signal of an input IF, performing a convolution integral based on an impulse response generated by an odd function for the real signal, and outputting a complex signal by suppressing one side of a positive frequency or a negative frequency, a local oscillator for outputting a complex local signal with a predetermined frequency, a complex mixer for performing frequency conversion by multiplying a real part of the complex signal output from the complex-coefficient transversal filter by a real part of the complex local signal output from the local oscillator, performing frequency conversion by multiplying an imaginary part of the complex signal by an imaginary part of the complex local signal output from the local oscillator, and outputting a real signal of a frequency separated by the predetermined frequency from a frequency of the input signal, and a real-coefficient filter for outputting a real RF signal by suppressing a frequency band out of an RF signal frequency band for the real signal output from the complex mixer. In accordance with the present invention, the frequency converter of a heterodyne scheme can lower an IF signal frequency to a low frequency, and can reduce power consumption in a structure after an IF stage.

When the frequency converters of the present invention are compared with the frequency converter constructing the downconverter using the conventional polyphase filter and the frequency converter for converting an IF signal to an RF signal of a frequency higher than an IF signal frequency, the frequency converters of the present invention can reduce loss due to the polyphase filter.

In the frequency converter of the present invention, the complex-coefficient transversal filter is constructed with a SAW filter. Since the SAW filter is a passive filter, power is not consumed. The SAW filter can suppress one side of a positive frequency or a negative frequency and can obtain the filter effect of suppressing a signal out of the band of a target signal at a frequency side.

In accordance with the present invention, the frequency converter is provided with a polyphase filter connected to the real-coefficient filter and the complex mixer. The complex mixer performs frequency conversion by multiplying a real part of the complex signal output from the complex-coefficient transversal filter by the real part of the complex local signal output from the local oscillator, performs frequency conversion by multiplying an imaginary part of the complex signal output from the complex-coefficient transversal filter by the imaginary part of the complex local signal output from the local oscillator, and outputs a complex signal of a frequency separated by the predetermined frequency from a frequency of the complex signal. The polyphase filter generates and outputs a real signal mapped to the complex signal output from the complex mixer by suppressing one side of a positive frequency or a negative frequency. Since the polyphase filter can generate a real IF signal by suppressing a positive or negative frequency component, an image frequency signal can be suppressed at a suppression ratio in which a suppression ratio of the complex mixer is added to a suppression ratio of the polyphase filter.

In the frequency converter of the present invention, the local oscillator outputs a real local signal with a predetermined frequency. The complex mixer performs frequency conversion by multiplying the real part of the complex signal output from the complex-coefficient transversal filter by the real local signal output from the local oscillator, performs frequency conversion by multiplying the imaginary part of the complex signal output from the complex-coefficient transversal filter by the real local signal output from the local oscillator, and outputs a complex signal of a frequency separated by the predetermined frequency from a frequency of the complex signal. Since a local signal input to the complex mixer is a real local signal, the power consumption of the frequency converter can be reduced to half of that of the frequency converter using the complex local signal. Using the real local signal, the frequency converter can obtain a sufficient suppression ratio at which an image frequency signal is suppressed by suppressing variation due to a manufacturing error of a mixer or filter without considering imbalance the between a real number and an imaginary number.

Although the exemplary embodiments of the present invention have been disclosed for illustrative purposes, those skilled in the art will appreciate that various modifications, additions, and substitutions are possible, without departing from the scope of the present invention. Therefore, the present invention is not limited to the above-described embodiments, but is defined by the following claims, along with their full scope of equivalents.

What is claimed is:

1. A frequency converter for frequency-converting a received radio frequency (RF) signal to an intermediate frequency (IF) signal, comprising:
a real-coefficient filter for outputting a real RF signal by suppressing a band out of an RF signal frequency band in a received signal;
a local oscillator for outputting a complex local signal with a predetermined frequency;
a complex mixer for performing frequency conversion by multiplying the real RF signal output from the real-coefficient filter by a real part of the complex local signal output from the local oscillator, performing frequency conversion by multiplying the real RF signal by an imaginary part of the complex local signal output from the local oscillator, and outputting a complex signal of a frequency separated by the predetermined frequency from a frequency of the real RF signal; and
a complex-coefficient transversal filter for performing a convolution integral based on an impulse response generated by an even function for a real part of the complex signal output from the complex mixer, performing a convolution integral based on an impulse response generated by an odd function for an imaginary part of the complex signal output from the complex mixer, and outputting a real signal from the complex signal by suppressing one side of a positive frequency or a negative frequency.

2. The frequency converter of claim 1, wherein the complex-coefficient transversal filter is constructed with a surface acoustic wave (SAW) filter.

3. The frequency converter of claim 1, further comprising:
a polyphase filter connected to the real-coefficient filter and the complex mixer,
wherein the polyphase filter generates and outputs a complex RF signal by suppressing one side of a positive frequency or a negative frequency from the real RF signal output from the real-coefficient filter, and
the complex mixer performs frequency conversion by multiplying a real part of the complex RF signal output from the polyphase filter by the real part of the complex local signal output from the local oscillator, performs frequency conversion by multiplying an imaginary part of the complex RF signal output from the polyphase filter by the imaginary part of the complex local signal output from the local oscillator, and outputs a complex signal of a frequency separated by the predetermined frequency from a frequency of the complex RF signal.

4. The frequency converter of claim 2, further comprising:
a polyphase filter connected to the real-coefficient filter and the complex mixer,
wherein the polyphase filter generates and outputs a complex RF signal by suppressing one side of a positive frequency or a negative frequency from the real RF signal output from the real-coefficient filter, and
the complex mixer performs frequency conversion by multiplying a real part of the complex RF signal output from the polyphase filter by the real part of the complex local signal output from the local oscillator, performs frequency conversion by multiplying an imaginary part of the complex RF signal output from the polyphase filter by the imaginary part of the complex local signal output from the local oscillator, and outputs a complex signal of a frequency separated by the predetermined frequency from a frequency of the complex RF signal.

5. The frequency converter of claim 3, wherein the local oscillator outputs a real local signal with a predetermined frequency, and
the complex mixer performs frequency conversion by multiplying the real part of the complex RF signal output from the polyphase filter by the real local signal output from the local oscillator, performs frequency conversion by multiplying the imaginary part of the complex RF signal output from the polyphase filter by the real local signal output from the local oscillator, and outputs a complex signal of a frequency separated by the predetermined frequency from a frequency of the complex RF signal.

6. The frequency converter of claim 4, wherein the local oscillator outputs a real local signal with a predetermined frequency, and
the complex mixer performs frequency conversion by multiplying the real part of the complex RF signal output from the polyphase filter by the real local signal output from the local oscillator, performs frequency conversion by multiplying the imaginary part of the complex RF signal output from the polyphase filter by the real local signal output from the local oscillator, and outputs a complex signal of a frequency separated by the predetermined frequency from a frequency of the complex RF signal.

7. A frequency converter for frequency-converting an input intermediate frequency (IF) signal to a radio frequency (RF) signal frequency, comprising:
a complex-coefficient transversal filter for performing a convolution integral based on an impulse response generated by an even function for a real signal of an input IF, performing a convolution integral based on an impulse response generated by an odd function for the real signal, and outputting a complex signal by suppressing one side of a positive frequency or a negative frequency;
a local oscillator for outputting a complex local signal with a predetermined frequency;
a complex mixer for performing frequency conversion by multiplying a real part of the complex signal output from the complex-coefficient transversal filter by a real part of the complex local signal output from the local oscillator, performing frequency conversion by multiplying an imaginary part of the complex signal by an imaginary part of the complex local signal output from the local oscillator, and outputting a real signal of a frequency separated by the predetermined frequency from a frequency of the input signal; and
a real-coefficient filter for outputting a real RF signal by suppressing a frequency band out of an RF signal frequency band for the real signal output from the complex mixer.

8. The frequency converter of claim 7, wherein the complex-coefficient transversal filter is constructed with a surface acoustic wave (SAW) filter.

9. The frequency converter of claim 7, further comprising:
a polyphase filter connected to the real-coefficient filter and the complex mixer,
wherein the complex mixer performs frequency conversion by multiplying a real part of the complex signal output from the complex-coefficient transversal filter by the real part of the complex local signal output from the local oscillator, performs frequency conversion by multiplying an imaginary part of the complex signal output from the complex-coefficient transversal filter by the imaginary part of the complex local signal output from the local oscillator, and outputs a complex signal of a frequency separated by the predetermined frequency from a frequency of the complex signal, and
the polyphase filter generates and outputs a real signal mapped to the complex signal output from the complex mixer by suppressing one side of a positive frequency or a negative frequency.

10. The frequency converter of claim 8, further comprising:
a polyphase filter connected to the real-coefficient filter and the complex mixer,
wherein the complex mixer performs frequency conversion by multiplying a real part of the complex signal output from the complex-coefficient transversal filter by the real part of the complex local signal output from the local oscillator, performs frequency conversion by multiplying an imaginary part of the complex signal output from the complex-coefficient transversal filter by the imaginary part of the complex local signal output from the local oscillator, and outputs a complex signal of a frequency separated by the predetermined frequency from a frequency of the complex signal, and
the polyphase filter generates and outputs a real signal mapped to the complex signal output from the complex mixer by suppressing one side of a positive frequency or a negative frequency.

11. The frequency converter of claim 9, wherein the local oscillator outputs a real local signal with a predetermined frequency, and
the complex mixer performs frequency conversion by multiplying the real part of the complex signal output from the complex-coefficient transversal filter by the real local signal output from the local oscillator, performs frequency conversion by multiplying the imaginary part of the complex signal output from the complex-coefficient transversal filter by the real local signal output from the local oscillator, and outputs a complex signal of a frequency separated by the predetermined frequency from a frequency of the complex signal.

12. The frequency converter of claim 10, wherein the local oscillator outputs a real local signal with a predetermined frequency, and
the complex mixer performs frequency conversion by multiplying the real part of the complex signal output from the complex-coefficient transversal filter by the real local signal output from the local oscillator, performs frequency conversion by multiplying the imaginary part of the complex signal output from the complex-coefficient transversal filter by the real local signal output from the local oscillator, and outputs a complex signal of a frequency separated by the predetermined frequency from a frequency of the complex signal.
